(19) United States
(12) Patent Application Publication
(10) Pub. No.: US 2014/0219469 A1
(43) Pub. Date: Aug. 7, 2014

(54) On-request wireless audio data streaming

(71) Applicant: Wavlynx, LLC, Vancouver, WA (US)

(72) Inventors: Jordan H. Geis, Portland, OR (US); George S. Vernon, Vanouver, WA (US)

(73) Assignee: WAVLYNX, LLC, Vacnouver, WA (US)

(21) Appl. No.: 14/149,745

(22) Filed: Jan. 7, 2014

Related U.S. Application Data
(60) Provisional application No. 61/749,807, filed on Jan. 7, 2013.

(51) Int. Cl. H04R 3/00

(52) U.S. Cl. CPC H04R 3/00
USPC 381/81

(57) ABSTRACT

An on-request wireless audio data streaming system is configured for providing on-request wireless audio data streaming to one or more wireless device apps on one or more wireless devices. The system comprises a directory server, audio capture interfaces and a wireless interface. The directory server coordinates the various components of the system. The audio capture interface obtains audio signals from sources of audio signals. The directory server maintains a list of available audio signals and broadcasts the list via the wireless interface. Wireless device apps receive the list, present it to their users. A user can select one of the available audio signals and request a subscription to it. The directory server maintains a list of the subscribed audio signals and associated subscribers. The audio capture interfaces generate and transmit via the wireless interface the audio data streams of the subscribed audio signals.

### FIELD OF THE INVENTION

The present invention relates to streaming of audio data. More particularly, the present invention relates to streaming audio data to wireless devices.

### BACKGROUND

Sports bars, gyms and similar venues often have multiple televisions or other video devices mounted on the walls, displaying different channels or programs/content on each. This allows multiple patrons to view a channel or program of their choice, no matter where they are in the room. These venues usually disable the audio for these video devices as the resulting cacophony from having all the audio turned on would be unpleasant and ineffective, as no-one would be able to hear the audio they want unless standing very close to the video device playing it. What is needed is a way for each patron of the venue to be able to hear the audio of the channel or program of their choice amongst those displayed on the wall mounted video devices without it being drowned out by the audio from the other video devices.

### SUMMARY AND ADVANTAGES

An on-request wireless audio data streaming system is configured for providing on-request wireless audio data streaming to one or more wireless device apps on one or more wireless devices. The wireless audio data streaming system comprises a directory server and one or more audio capture interfaces and a wireless interface. The directory server coordinates the various components of the system. The audio capture interface obtains audio signals from sources of audio signals. The directory server maintains a list of available audio signals and broadcasts the list via the wireless interface. Wireless device apps receive the list, present it to their users. A user can select one of the available audio signals and request a subscription to it. The directory server maintains a list of the subscribed audio signals and associated subscribers. The audio capture interfaces generate and transmit via the wireless interface the audio data streams of the subscribed audio signals.

The on-request wireless audio data streaming system is capable of supporting multiple simultaneous streams of audio data. Broadcast streams are actively compressed and employ “graceful” degradation of the signal based on the number of streams alive at any given time to provide margin to the broadcast bandwidth and minimize packet collisions. The audio streams will be broadcast using the multicast IP protocol so multiple subscribers may attach to it.

### BRIEF DESCRIPTION OF THE DRAWINGS

The present invention will be described by way of exemplary embodiments, but not limitations, illustrated in the accompanying drawings in which like references denote similar elements, and in which:

The accompanying drawings, which are incorporated into and constitute a part of this specification, illustrate one or more embodiments of the invention and, together with the detailed description, serve to explain the principles and implementations of the invention.

FIG. 1 is a view of an on-request wireless audio data streaming system.

FIG. 2 is a view of an on-request wireless audio data streaming system in which each audio capture interface is part of a separate source server.

FIG. 3 is a block diagram that illustrates a general purpose computer system upon which components of the invention may be implemented.

FIG. 4 shows a view of a wearable wireless device 160 used with the on-request wireless audio data streaming system of FIG. 2.

### DETAILED DESCRIPTION

Before beginning a detailed description of the subject invention, mention of the following is in order. When appropriate, like reference materials and characters are used to designate identical, corresponding, or similar components in different figures. The figures associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Use of directional terms such as “upper,” “lower,” “above,” “below”, “in front of,” “behind,” etc. are intended to describe the positions and/or orientations of various components of the invention relative to one another as shown in the various Figures and are not intended to impose limitations on any position and/or orientation of any embodiment of the invention relative to any reference point external to the reference.

Those skilled in the art will recognize that numerous modifications and changes may be made to the embodiments described herein without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

### System Overview

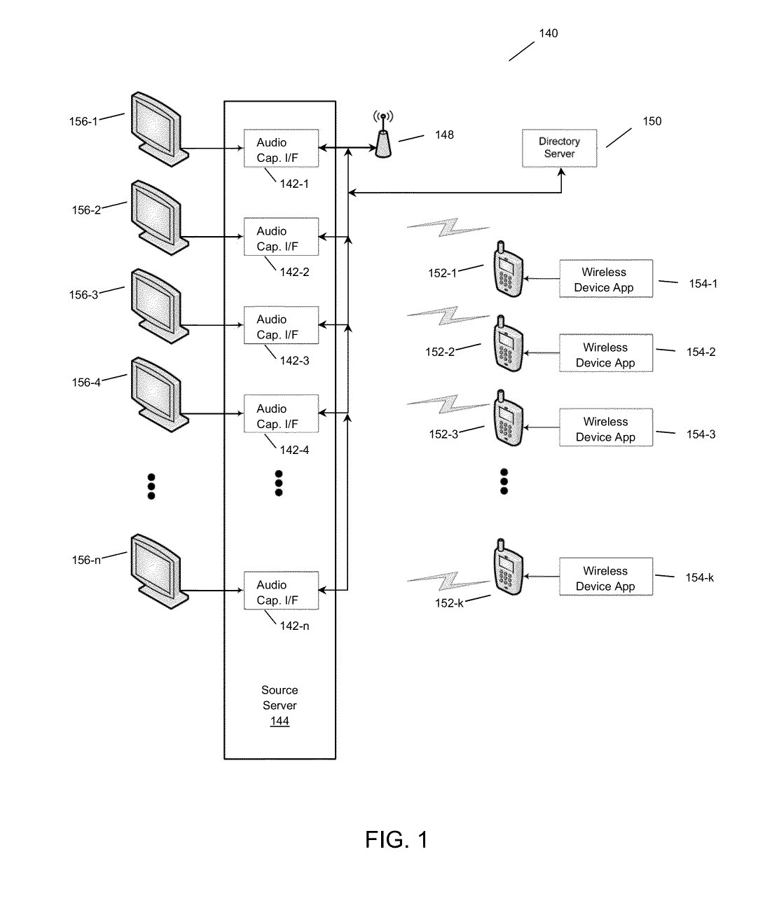

FIG. 1 shows an embodiment of an on-request wireless audio data streaming system 140. The on-request wireless audio data streaming system 140 is configured for providing on-request wireless audio data streaming to one or more wireless device apps on one or more wireless devices. The on-request wireless audio data streaming system 140 obtains audio signals from one or more sources of audio signals. For example, in FIG. 1, the sources of the audio signals are n number of video devices 156. The wireless audio data streaming system 140 comprises a directory server 150 and one or more audio capture interfaces 142 and a wireless interface 148. The one or more audio capture interfaces 142 are networked with the wireless interface 148 and with the directory server 150. In the preferred embodiment, the links between the audio capture interfaces 142, the wireless interface 148 and the directory server 150 are wired Ethernet links, but in other embodiments may be wireless links or use another protocol.

### The Wireless Interface

The wireless interface 148 is configured for communicating with one or more wireless devices 152. More specifically, the wireless interface 148 is configured for communicating with one or more wireless device apps 154 that have been loaded onto one or more wireless devices 152. The wireless interface 148 uses WiFi protocol in the preferred embodiment, but in other embodiments may use Bluetooth or other suitable protocols.

The wireless device apps 154 have been customized for working with the on-request wireless audio data streaming system 140. Other wireless devices, not loaded with the wireless device app 154, may come within range of the wireless interface 148, but will not work with the on-request wireless audio data streaming system 140 and are not considered further herein. Hence FIG. 1 shows k number of wireless device apps 154 loaded on k number of wireless devices 152.

The wireless interface 148 is configured to use a multicast protocol when broadcasting information. The wireless interface 148 is configured to use a unicast protocol when communicating with a specific wireless device app 154.

### The Audio Capture Interfaces

The one or more audio capture interfaces 142 are configured for receiving a set of audio signals. Each audio capture interface 142 in the set of audio capture interfaces is associated with one of the audio signals. FIG. 1 shows n number of audio capture interfaces 142 receiving n number of audio signals from n number of video devices 156. The audio capture interface 142 may receive audio signals in analog or digital form. The audio capture interfaces 142 are further configured for generating a set of audio data streams, converting the audio signal for packet transmission. Each audio capture interface 142 is configured for generating one of the audio data streams from the audio signal associated with that audio capture interface. However, each audio capture interface 142 is configured to generate its associated audio data stream only if its associated audio signal has at least one subscribing wireless device app associated with that audio signal. When no subscriber exists for a given audio signal, the audio capture interface 142 will not generate any audio data stream. Alternatively, when no subscriber exists for a given audio signal, the audio capture interface 142 may generate an audio data stream but will not transmit it to the wireless interface 148 for broadcast. Which audio signals have at least one associated subscribing wireless device app is tracked by the directory server 150, which communicates any changes to subscription status of the audio signals to the audio capture interfaces 142 as necessary. The audio capture interfaces 142 transmit the audio data streams to the wireless interface 148 for broadcasting.

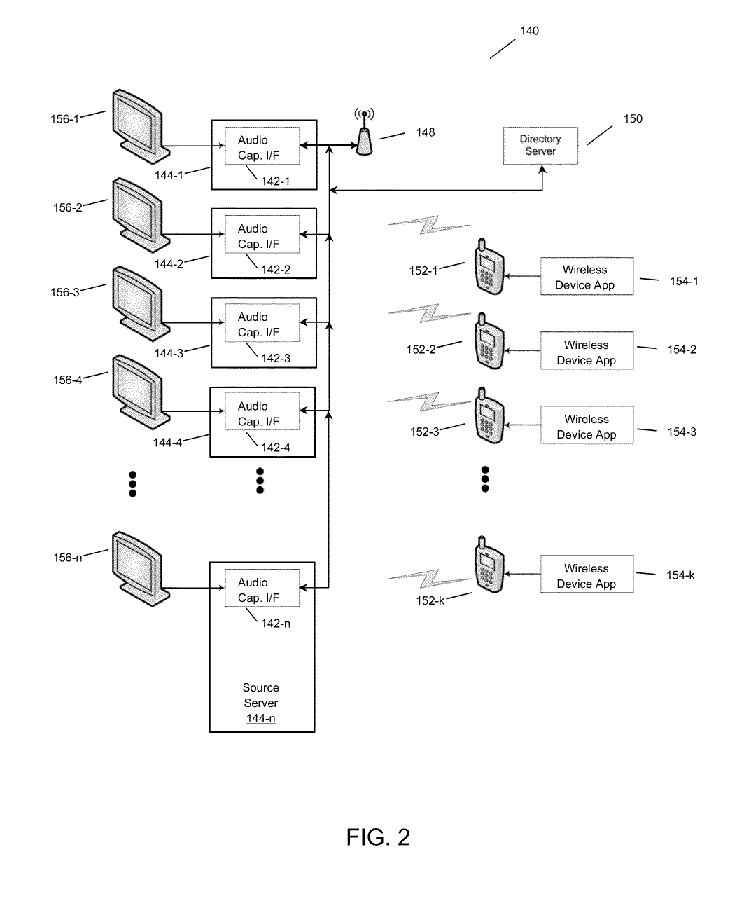

The one or more audio capture interfaces 142 are part of one or more source servers 144. FIG. 1 shows n number of audio capture interfaces 142 as part of a single source server 144. In a typical embodiment, the audio capture interfaces 142 are software modules loaded on and executed by the source servers 144. A single source server 144, such as a dedicated PC, may be used to store and execute the software modules embodying the audio capture interfaces 142. FIG. 1 shows n number of audio capture interfaces 142 on a single source server 144. However, more than one source server 144 may be used. Multiple source servers 144 may be used if the audio signals to be streamed are numerous enough that load-balancing is necessary to maintain adequate performance. Multiple source servers 144 may be used if the audio signals have a limited range and their sources are widely dispersed. In some embodiments, each audio capture interface 142 is embodied on its own source server 144. FIG. 2 shows n number of audio capture interfaces 142 as part of n number of source servers 144. This would be a likely configuration if some or all of the functions of the audio capture interfaces 142 are embodied as discrete hardware rather than software.

In some embodiments, the audio capture interfaces 142 may also have functions for handling video signals associated with the audio signals. Audio capture interfaces 142 with video functions are each further configured for receiving a video signal associated with the audio signal that the audio capture interface 142 is processing. For example, in FIG. 1 the n number of audio capture interfaces 142 receiving the n number of audio signals from the n number of video devices 156 would also be receiving n number of video signals from the n number of video devices 156. Audio capture interfaces 142 with video functions are each further configured for introducing an amount of delay into the video signal. The delayed video signal is then transmitted back to the video devices 156. The amount of delay may be selected to compensate for the delay in the audio stream, so that a user of one of the wireless device apps 154 hears the audio in sync with the video on the video device 156.

In some embodiments, some or all of the audio capture interfaces 142 also have functions for compressing their respective audio data streams. Multiple degrees of compression might be provided by the audio capture interfaces 142 to degrade audio quality as the number of streams being transmitted by the wireless interface 148 increases. In the preferred embodiment, the OggVorbis compression algorithm is used, but in other embodiments, another suitable compression algorithm may be used.

In some embodiments, some or all of the audio capture interfaces 142 also have functions for encrypting their respective audio data streams. An audio capture interface 142 with encryption functions is configured to generate a decryption key suitable for decrypting the audio data stream associated with that audio capture interface. Such audio capture interfaces are configured for transmitting the decryption key, via the wireless interface, to wireless device apps subscribing to the associated audio signal. In some embodiments, some or all of the audio capture interfaces 142 also are configured for encoding audio data streams with error correction.

### The Directory Server

The directory server 150 coordinates the activities of the various components of the on-request wireless audio data streaming system 140. The directory server 150 manages subscribers and verifies continuing existence of subscribers.

The directory server 150 is configured for maintaining a list of available audio signals. This list is based on the audio signals associated with one of the audio capture interfaces 142. The audio capture interfaces 142 communicate with the directory server 150, sending it updates of the audio signals available. Each audio capture interface 142 sends information about the availability of its associated audio signal. The directory server 150 is further configured for broadcasting, via the wireless interface, the list of the available audio signals.

The directory server 150 is further configured for maintaining a list of subscribing wireless devices, or more specifically, a list of subscribing wireless device apps. The directory server 150 associates each subscribing wireless device app with the audio signal to which it subscribed and records the association in the list. The directory server 150 is further configured for querying the subscribing wireless device apps 154 to ensure that each is still engaged with its associated audio signal. If one of the wireless device apps 154 does not respond to the query—perhaps because the wireless device 152 carrying it has moved out of range—then the directory server 150 removes that wireless device app 154 from the list of subscribing wireless devices/device apps. The directory server 150 is configured to receive requests from a subscribing wireless device app 154 to cancel or change its subscription. The directory server 150 then changes the list of subscribing wireless devices/device apps accordingly.

In some embodiments, the directory server 150 is further configured for transmitting, via the wireless interface 148, data to one of the wireless device apps 154 after that wireless device app 154 has established contact with the directory server 150. This would allow the operator of the on-request wireless audio data streaming system 140 to push some content to the user prior to connecting the user to the subscribed audio data stream. Such content could be an advertisement or theme song for the establishment operating the system.

### Wireless Device App

The wireless device app 154 allows a user to view available audio signals, select one, and then will receive and present an audio data stream of the selected audio signal to the user. The wireless device app 154 is configured for receiving a list of available audio signals from the directory server 150. The wireless device app 154 can then display the available audio signals. The user of the wireless device app 154 can then select to subscribe and receive one of the available audio signals, or the wireless device app 154 may be set up to automatically select a signal. The wireless device app 154 is further configured for transmitting a request to subscribe to the selected audio signal. The wireless device app 154 is further configured for receiving an audio data stream. The audio data stream received is one that is generated from the audio signal requested by wireless device app 154. The wireless device app 154 is further configured for playing the audio data stream over a speaker on the wireless device 152, most likely a headset so that the user can listen without disturbing others.

In some embodiments, the wireless device app 154 is further configured to determine the location and orientation of the wireless device 152 on which the wireless device app 154 is loaded, then make a request for content based on the location and orientation of the wireless device. In such embodiments, a user of a wireless device 152 can subscribe to an audio signal by pointing the device at a particular object such as one of the video devices 156. The necessary calculations could be performed on the wireless device 152, on the directory server 150 or some other server. This would be particularly useful for a wearable wireless device 152 that is worn on the user's person.

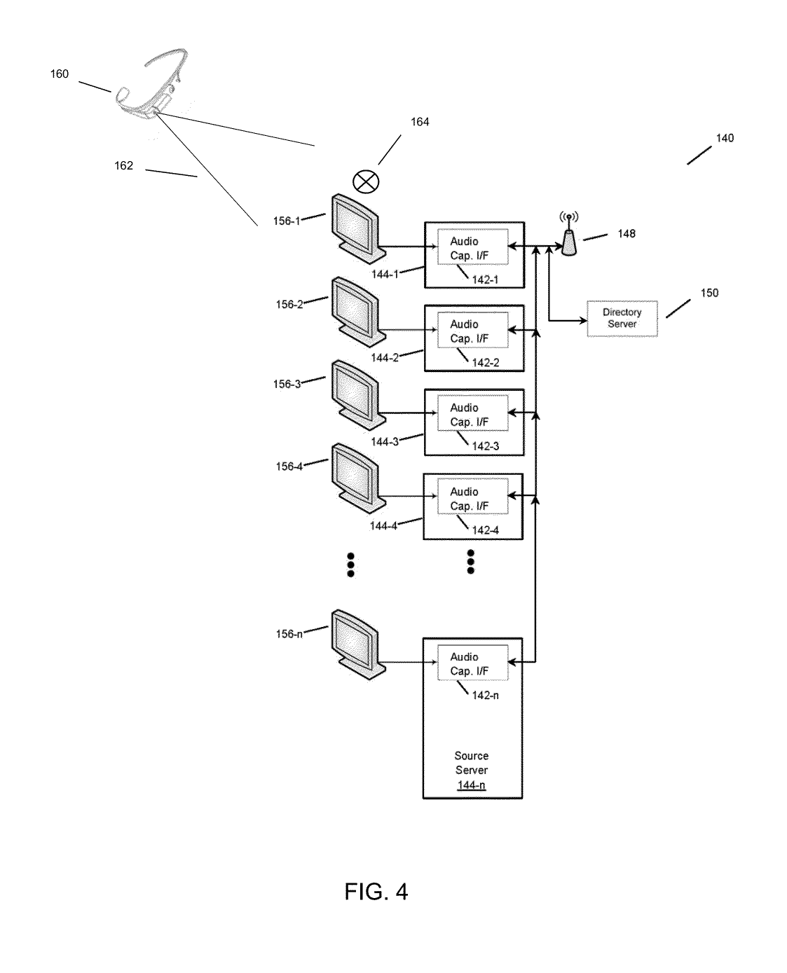

FIG. 4 shows a view of a wearable wireless device 160 used with the on-request wireless audio data streaming system as of FIG. 2. The wearable wireless device 160 in FIG. 4 is shown as a head set with a camera, a computer and a wireless transceiver. The wearable wireless device 160 is loaded with the wireless device app 154. As described previously, in some embodiments the wireless device app 154 is configured to make a request for content based on the location and orientation of the wearable wireless device 160. The user of the wearable wireless device 160 could subscribe to and receive the audio data stream of one of the video devices 156 if the user and the wearable wireless device 160 are close to that video device 156 and facing it.

In some embodiments, the wireless device app 154 is configured to select an audio signal based on visual information from a camera in the wearable wireless device 160. The audio signal could be selected based on machine vision identification of a particular object, such as a video device generally or specifically one particular video display 156 in a particular venue. Alternatively, selection could be based upon machine vision identification of a target 164 positioned near the video display 156. The target 164 would of color and shape that is easy for machine vision identification. The camera on wearable wireless device 160 has a field of vision 162 that is pointing in the same direction that the user wearing is facing and likely encompasses what the user is looking at. Thus the user could change the audio data stream that he/she is receiving by just changing which video display 156 he/she is looking at. The machine vision identification could be performed on the wearable wireless device 160, on the directory server 150 or on some other server.

### Operation of the System

The wireless device app 154 is configured to present a text description of the available audio signals in a scrolling menu. The user then selects the desired audio signal by tapping on the description field (this may also be done by highlighting the desired selection and incorporating a PLAY type control button as part of the description or app).

Once the user has selected an audio signal, the wireless device app 154 sends a request to the directory server 150 for a subscription to the selected audio signal. The directory server 150 informs the appropriate audio stream interface 142 of a pending connection so it can begin broadcasting an audio data stream of the selected audio signal (if it is not broadcasting already). The broadcasting information (multicast IP) for that audio data stream is passed to the wireless device app 154 so that it can begin receiving the audio data stream.

Periodically, the directory server 150 will query the subscribing wireless device app 154 to ensure it is still engaged with the subscribed audio data stream. If the wireless device app 154 disconnects from the audio data stream or drops out due to loss of signal, the directory server 150 will remove that wireless device app 154 from the list of subscribers for that audio data stream. If the list for that audio data stream is no longer populated, the directory server 150 will inform the appropriate audio capture interface 142 so that the stream can be removed from the multiplexed data transmitted by the wireless interface 148.

### General Purpose Computer System Architecture

Several of the components of the on-request wireless audio data streaming system 140 are general purpose computer systems. The architecture of a standard general purpose computer system is described below.

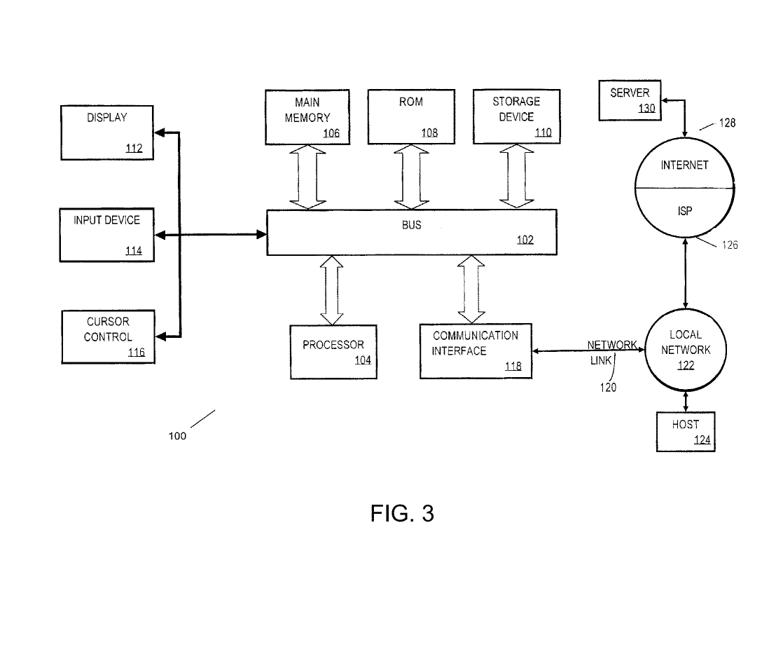

FIG. 3 is a block diagram that illustrates a general purpose computer system 100 upon which components of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variable or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

According to one embodiment of the invention, several functions of the on-request wireless audio data streaming system 140 are provided by a processor 104 in one of the system's components executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. One or more processors in a multi-processing arrangement may also be employed to execute the sequences of instructions contained in main memory 106. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including, but not limited to, nonvolatile media, volatile media, and transmission media. Nonvolatile media include, for example, optical or magnetic disks, such as storage device 110. Volatile media include dynamic memory, such as main memory 106. Transmission media include coaxial cables, copper wire, and fiber optics, including the wires that comprise bus 102. Transmission media can also take the form of acoustic or light waves, such as those generated during radio frequency (RF) and infrared (IR) data communications. Common forms of computer-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEPROM, any other memory chip or cartridge, a carrier wave as described hereinafter, or any other medium from which a computer can read.

Various forms of computer-readable media may be involved in carrying one or more sequences of one or more instructions to processor 104 for execution. For example, the instructions may initially be borne on a magnetic disk of a remote computer. The remote computer can load the instructions into its dynamic memory and send the instructions over a telephone line using a modem. A modem local to computer system 100 can receive the data on the telephone line and use an infrared transmitter to convert the data to an infrared signal. An infrared detector coupled to bus 102 can receive the data carried in the infrared signal and place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic, or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the worldwide packet data communication network, now commonly referred to as the “Internet” 128. Local network 122 and Internet 128 both use electrical, electromagnetic, or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program codes, through the network(s), network link 120, and communication interface 118. In the Internet example, a server 130 might transmit a requested code for an application program through Internet 128, ISP 126, local network 122, and communication interface 118. In accordance with one aspect of the invention, one such downloaded application provides for the wireless device app 154 as described herein.

The received code may be executed by processor 104 as it is received, and/or stored in storage device 110, or other nonvolatile storage for later execution. In this manner, computer system 100 may obtain an application code in the form of a carrier wave.

What is claimed is:

1. A system for providing on-request wireless audio data streaming to one or more wireless devices, comprising:
a wireless interface configured for communicating with the one or more wireless devices;
one or more source servers configured for receiving a set of audio signals;
the one or more source servers further configured for generating a set of audio data streams, generating each of the audio data streams from one of the audio signals that has at least one subscribing wireless device associated with that audio signal;
the one or more source servers further configured for broadcasting, via the wireless interface, the set of audio data streams.
a directory server configured for maintaining a list of available audio signals based on the audio signals received by the one or more source servers;
the directory server further configured for broadcasting, via the wireless interface, the list of the available audio signals;
the directory server further configured for monitoring for requests from the one or more wireless devices for subscribing to one of the available audio signals; and
the directory server further configured for maintaining a list of subscribing wireless devices, each subscribing wireless device associated with one of the available audio signals.

2. The system of claim 1,
wherein the one or more source servers are further configured for receiving a set of video signals, each video signal in the set of video signals associated with one of the audio signals in the set of audio signals;
wherein the one or more source servers are further configured for delaying one or more of the set of video signals to create a set of delayed video signals; and
wherein the one or more source servers are further configured for transmitting the set of delayed video signals to a set of video devices.

3. The system of claim 1,
wherein the directory server is further configured for querying one of the subscribing wireless devices to ensure that subscribing wireless device is still engaged with its associated audio signal.

4. The system of claim 1,
wherein the directory server is further configured for transmitting, via the wireless interface, a set of data to one of the one or more wireless devices after that wireless device has established contact with the directory server.

5. The system of claim 1,
wherein the wireless interface broadcasts the set of audio data streams using a multicast protocol.

6. A system for providing on-request wireless audio data streaming to one or more wireless device apps on one or more wireless devices, comprising:
a wireless interface configured for communicating with the one or more wireless device apps;
one or more source servers having a set of audio capture interfaces configured for receiving a set of audio signals, each audio capture interface in the set of audio capture interfaces associated with one of the audio signals in the set of audio signals;
the set of audio capture interfaces further configured for generating a set of audio data streams, each audio capture interface in the set of audio capture interfaces generating one of the audio data streams in the set of audio data streams from the audio signal associated with that audio capture interface, if that audio signal has at least one subscribing wireless device app associated with that audio signal;
the set of audio capture interfaces further configured for broadcasting, via the wireless interface, the set of audio data streams.
a directory server configured for maintaining a list of available audio signals based on the audio signals associated with one of the audio capture interfaces in the set of audio capture interfaces;
the directory server further configured for broadcasting, via the wireless interface, the list of the available audio signals;
the directory server further configured for monitoring for requests from the one or more wireless device apps for subscribing to one of the available audio signals; and
the directory server further configured for maintaining a list of subscribing wireless device apps, each subscribing wireless device app associated with one of the available audio signals.

7. The system of claim 6,
wherein the set of audio capture interfaces are further configured for receiving a set of video signals, each video signal in the set of video signals associated with one of the audio signals in the set of audio signals;
wherein the set of audio capture interfaces are further configured for delaying one or more of the set of video signals to create a set of delayed video signals; and
wherein the set of audio capture interfaces are further configured for transmitting the set of delayed video signals to a set of video devices.

8. The system of claim 6,
wherein the directory server is further configured for querying one of the subscribing wireless device apps to ensure that subscribing wireless device app is still engaged with its associated audio signal.

9. The system of claim 6,
wherein the set of audio capture interfaces are further configured for compressing the set of audio data streams, each audio capture interface in the set of audio capture interfaces compressing the audio data stream in the set of audio data streams associated with that audio capture interface.

10. The system of claim 6,
wherein the set of audio capture interfaces are further configured for encrypting, by at least one of the set of audio capture interfaces, that audio data stream in the set of audio data streams associated with that audio capture interface;
wherein the set of audio capture interfaces are further configured for generating, by the at least one of the set of audio capture interfaces, a decryption key suitable for decrypting the audio data stream associated with that audio capture interface; and
wherein the set of audio capture interfaces are further configured for transmitting, via the wireless interface, the decryption key, to wireless device apps subscribing to the associated audio signal.

11. A method for a system for providing on-request wireless audio data streaming to one or more wireless device apps on one or more wireless devices, the steps of the method comprising:
(a) receiving, by a set of audio capture interfaces, a set of audio signals, each audio capture interface in the set of audio capture interfaces associated with one of the audio signals in the set of audio signals;
(b) maintaining, by a directory server, a list of available audio signals based on the audio signals associated with one of the audio capture interfaces in the set of audio capture interfaces;
(c) broadcasting, by a wireless interface, the list of the available audio signals;
(d) monitoring, by the directory server, for requests from the one or more wireless device apps for subscribing to one of the available audio signals;
(e) maintaining, by the directory server, a list of subscribing wireless device apps, each subscribing wireless device app associated with one of the available audio signals;
(f) generating, by the set of audio capture interfaces, a set of audio data streams, each audio capture interface in the set of audio capture interfaces generating one of the audio data streams in the set of audio data streams from the audio signal associated with that audio capture interface, if that audio signal has at least one subscribing wireless device app associated with that audio signal; and
(g) broadcasting, by the wireless interface, the set of audio data streams.

12. The method of claim 11, further comprising the steps of:
(h) receiving, by the set of audio capture interfaces, a set of video signals, each video signal in the set of video signals associated with one of the audio signals in the set of audio signals;
(i) delaying one or more of the set of video signals to create a set of delayed video signals; and
(j) transmitting the set of delayed video signals to a set of video devices.

13. The method of claim 11,
wherein step (f) further comprises the step of (k) querying one of the subscribing wireless device apps to ensure that subscribing wireless device app is still engaged with its associated audio signal.

14. The method of claim 11,
wherein step (e) further comprises the step of (l) compressing, by the set of audio capture interfaces, the set of audio data streams, each audio capture interface in the set of audio capture interfaces compressing the audio data stream in the set of audio data streams associated with that audio capture interface.

15. The method of claim 11,
wherein step (e) further comprises the step of (m) encrypting, by at least one of the set of audio capture interfaces, that audio data stream in the set of audio data streams associated with that audio capture interface;
wherein step (e) further comprises the step of (n) generating, by the at least one of the set of audio capture interfaces, a decryption key suitable for decrypting the audio data stream associated with that audio capture interface; and
further comprising the step of (o) broadcasting, by the wireless interface, the decryption key.

16. The method of claim 11,
wherein step (e) further comprises the step of (p) encoding with error correction, by at least one of the set of audio capture interfaces, that audio data stream in the set of audio data streams associated with that audio capture interface.

17. The method of claim 11, further comprising the steps of:
(q) transmitting, by directory server via the wireless interface, a set of data to one of the one or more wireless device apps after that wireless device app has established contact with the directory server.

18. The method of claim 11,
wherein step (g) further comprises the step of (r) using a multicast protocol.

19. A computer-readable medium having stored thereon instructions which, when executed by a processor, part of a wireless device, cause the processor to perform the steps of:
(a) receiving a list of available audio signals;
(b) transmitting a request to subscribe to one of the available audio signals;
(c) receiving an audio data stream generated from one of the available audio signals to which the wireless device has requested to subscribe; and
(d) playing the audio data stream over a speaker.

20. The computer-readable medium of claim 19 having stored thereon additional instructions which, when executed by the processor, part of the wireless device, cause the processor to perform the steps of:
determining a location of the wireless device;
determining an orientation of the wireless device; and
transmitting a request for content based on the location and orientation of the wireless device.

21. The computer-readable medium of claim 19 having stored thereon additional instructions which, when executed by the processor, part of the wireless device, cause the processor to perform the steps of:
receiving visual data from the wireless device;
identifying an object in the visual data; and
transmitting a request for content based the object identified.
